(19) United States
(12) Patent Application Publication
(10) Pub. No.: US 2020/0233839 A1
(43) Pub. Date: Jul. 23, 2020

(54) DEFRAGMENTING METADATA OF A FILESYSTEM

(71) Applicant: Apple Inc., Cupertino, CA (US)

(72) Inventors: Meha N. DESAI, San Francisco, CA (US); Eric B. TAMURA, Sunnyvale, CA (US)

(21) Appl. No.: 16/673,820

(22) Filed: Nov. 4, 2019

Related U.S. Application Data
(60) Provisional application No. 62/795,500, filed on Jan. 22, 2019.

(51) Int. Cl. G06F 16/17; G06F 16/13; G06F 8/65

(52) U.S. Cl. CPC G06F 16/1724; G06F 8/65; G06F 16/13

(57) ABSTRACT

A device implementing a system for defragmenting metadata of a filesystem includes a processor configured to, in response to receiving a trigger from a server remote from the device, obtain the metadata from a first data structure, the first data structure comprising a first set of one or more nodes and a second set of one or more nodes, and insert the metadata obtained from the first data structure into a third set of one or more nodes of a second data structure, wherein the third set of one or more nodes omits one or more entries from the second set of nodes. The at least one processor is further configured to, in accordance with a determination that the metadata was successfully inserted into the second data structure, provide the second data structure as a replacement of the first data structure for the filesystem.

### TECHNICAL FIELD

The present description relates generally to filesystem metadata, including defragmenting metadata of a filesystem.

### BACKGROUND

A filesystem may use a data structure to store metadata associated with files managed by the filesystem, such as files corresponding to an operating system and its applications.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment for defragmenting metadata of a filesystem in accordance with one or more implementations.

FIG. 2 illustrates an example device that may implement a system for defragmenting metadata of a filesystem in accordance with one or more implementations.

FIG. 3 illustrates an example of extracting metadata from a first data structure to generate a second data structure with less fragmentation of metadata in accordance with one or more implementations.

FIG. 4 illustrates an example process for defragmenting metadata of a filesystem in accordance with one or more implementations.

FIG. 5 illustrates an example electronic system with which aspects of the subject technology may be implemented in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

As noted above, a filesystem may use a data structure (e.g., a B-tree) to store metadata associated with the files managed by the filesystem. For example, the filesystem may manage files corresponding to an operating system and its applications, and the B-tree may store the metadata associated with these files, such as filenames, extension types, etc.

It may be desirable for B-tree space utilization for a filesystem to be high, such as to provide for optimal packing and/or fast retrieval of metadata records. However, B-tree space utilization for filesystem metadata may become suboptimal in some cases. For example, when operating system updates are downloaded and installed, the updates may change the files managed by the filesystem, thereby changing the metadata of the filesystem. In another example, when replacing a file system, metadata may be added to the B-tree without being sorted first, or metadata may be added in a sort order that differs from the sort order utilized by the B-tree. Thus, the B-tree may become suboptimal (e.g., fragmented and/or sparsely packed). For example, a suboptimal B-tree may include empty entries within nodes and/or empty nodes (e.g., node with no metadata), with the nodes corresponding to leaf nodes of the B-tree.

The subject system provides for defragmenting the metadata of a filesystem. In response to a triggering event (e.g., an instruction received as part of an operating system update, where the operating system update causes the B-tree to become suboptimal), the device extracts metadata from nodes of a first B-tree (e.g., a suboptimal B-tree, corresponding to metadata that is sparsely-packed), and inserts the extracted metadata into a second B-tree for replacing the first B-tree. The metadata may be inserted (e.g., sequentially inserted) into the second B-tree by omitting empty entries and/or empty nodes within the first B-tree. As such, the second B-tree may include metadata entries that are more densely-packed when compared to the first B-tree. Use of the second B-tree when compared to the first B-tree may provide for reduced storage space and/or faster access time (e.g., reduced read counts) associated with the metadata.

Moreover, the subject system may implement a crash protection mechanism, which provides the second B-tree as a replacement of the first B-tree, after determining that all of the metadata was successfully inserted into the second B-tree. As such, the second B-tree may be committed as the replacement of the first B-tree after successful insertion of all of the metadata. If all of the metadata is not successfully inserted (e.g., the insertions are interrupted due to a system crash), the device continues using the first B-tree for the filesystem metadata.

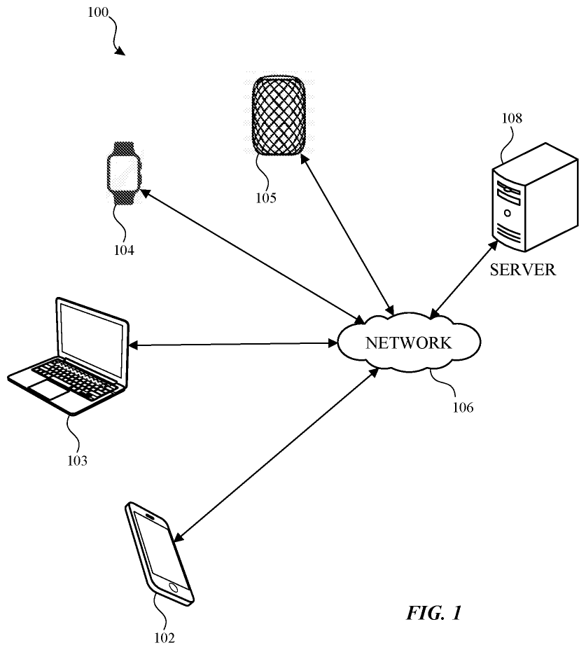

FIG. 1 illustrates an example network environment for defragmenting metadata of a filesystem in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes electronic devices 102, 103, 104 and 105 (hereinafter 102-105), a network 106 and a server 108. The network 106 may communicatively (directly or indirectly) couple, for example, any two or more of the electronic devices 102-105 and the server 108. In one or more implementations, the network 106 may be an interconnected network of devices that may include, and/or may be communicatively coupled to, the Internet. For explanatory purposes, the network environment 100 is illustrated in FIG. 1 as including electronic devices 102-105 and a single server 108; however, the network environment 100 may include any number of electronic devices and any number of servers.

One or more of the electronic devices 102-105 may be, for example, a portable computing device such as a laptop computer, a smartphone, a smart speaker, a peripheral device (e.g., a digital camera, headphones), a tablet device, a wearable device such as a smartwatch, a band, and the like, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a smartphone, the electronic device 103 is depicted as a laptop computer, the electronic device 104 is depicted as a smartwatch, and the electronic device 105 is depicted as a smart speaker.

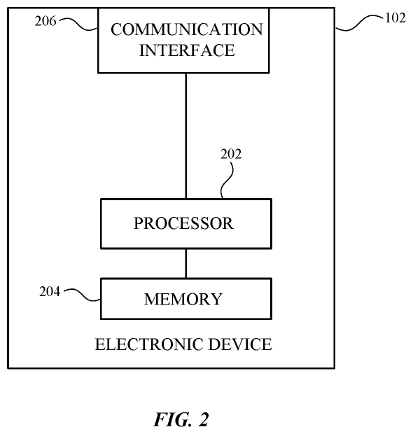

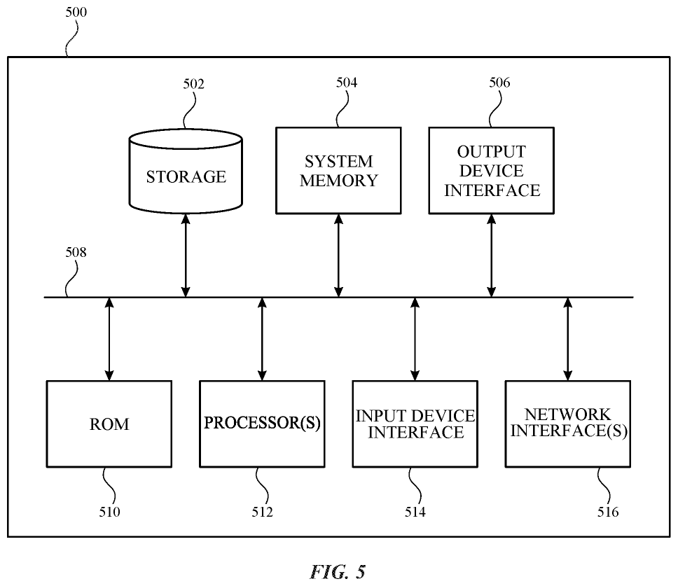

The electronic devices 102-105 may be configured to communicate or otherwise interact with the server 108, for example, to download and install an operating system update. This may happen periodically, for example, based on predefined settings of the electronic devices 102-105. For example, a user may be prompted to download the operating software update from the server 108 and install the update, when the electronic device(s) 102-105 are plugged in at night (e.g., a time during which power may not be a concern), and/or when the electronic device(s) 102-105 are paired with a Wi-Fi base station. Each of the electronic devices 102-105 may be, and/or may include all or part of, the device discussed below with respect to FIG. 2, and/or the electronic system discussed below with respect to FIG. 5.

The server 108 may be, and/or may include all or part of the electronic system discussed below with respect to FIG. 5. The server 108 may include one or more servers, such as a cloud of servers, that may be used to provide an operating system update to one of more of the electronic devices 102-105. For explanatory purposes, a single server 108 is shown and discussed with respect to various operations. However, these and other operations discussed herein may be performed by one or more servers, and each different operation may be performed by the same or different servers.

FIG. 2 illustrates an example device that may implement a system for defragmenting metadata of a filesystem in accordance with one or more implementations. For explanatory purposes, FIG. 2 is primarily described herein with reference to the electronic device 102. However, FIG. 2 may correspond to any of the electronic devices 102-105 of FIG. 1. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The electronic device 102 may include a processor 202, a memory 204, and a communication interface 206. The processor 202 may include suitable logic, circuitry, and/or code that enable processing data and/or controlling operations of the electronic device 102. In this regard, the processor 202 may be enabled to provide control signals to various other components of the electronic device 102. The processor 202 may also control transfers of data between various portions of the electronic device 102. Additionally, the processor 202 may enable implementation of an operating system or otherwise execute code to manage operations of the electronic device 102.

The memory 204 may include suitable logic, circuitry, and/or code that enable storage of various types of information such as received data, generated data, code, and/or configuration information. The memory 204 may include, for example, random access memory (RAM), read-only memory (ROM), flash, and/or magnetic storage.

In one or more implementations, the memory 204 may store files corresponding to one of more applications (e.g., applications included with an operating system, and/or third-party applications). The files may be managed by a filesystem, which may store metadata for the files within a data structure (e.g., a B-tree).

The communication interface 206 may include suitable logic, circuitry, and/or code that enables wired or wireless communication, such as between any of the electronic devices 102-105 and the server 108 over the network 106. The communication interface 206 may include, for example, one or more of a Bluetooth communication interface, a cellular interface, an NFC interface, a Zigbee communication interface, a WLAN communication interface, a USB communication interface, or generally any communication interface.

In one or more implementations, one or more of the processor 202, the memory 204, the communication interface 206, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

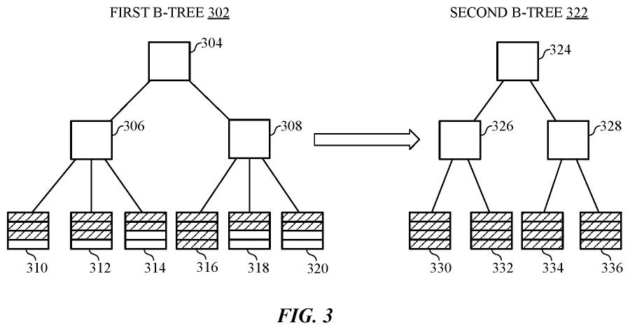

FIG. 3 illustrates an example of extracting metadata from a first data structure to generate a second data structure with less fragmentation of metadata in accordance with one or more implementations. For explanatory purposes, FIG. 3 is primarily described herein with reference to the electronic device 102. However, FIG. 3 may correspond to any of the electronic devices 102-105 of FIG. 1. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

As noted above, the electronic device 102 may store files corresponding to one or more applications. For example, an operating system may include a predefined (e.g., default) set of applications that are installed on the electronic device 102. In another example, a user may download third party applications that are not included with an operating system. The filesystem may manage the files corresponding to those the default applications and/or the third party applications. Moreover, the filesystem may store metadata of these files. For a given file, the metadata may include, but is not limited to, one of more of a file name, one or more dates, a file extension, a directory and/or an extension attribute.

In one or more implementations, the operating system files, default applications and/or third party applications may be stored on a read-only partition of the electronic device 102 that may be separate from the partition that stores user data. Thus, since the partition is read-only (and therefore may only be updated when the operating system and/or applications are updated), the metadata corresponding to the operating system files, default applications, and/or third party applications may remain unchanged outside of operating system and/or application updates.

In one or more implementations, the metadata for the files of the filesystem may be stored in a data structure. In the example of FIG. 3, the data structure is a B-tree, which maintains the metadata across multiple nodes based on a sort order. The B-tree may provide for searching, inserting and/or deleting the metadata stored in the nodes.

FIG. 3 illustrates a first B-tree 302 with nodes 304-320. The first B-tree 302 may include a primary node 304, index nodes 306-308 and leaf nodes 310-320. The file metadata is stored in the leaf nodes 310-320, while the primary node 304 and the index nodes 306-308 may provide for searching and/or updating the metadata included in the leaf nodes 310-320.

In one or more implementations, a given leaf node may store all of the metadata for a file (e.g., or one or more files), provided that the metadata fits in the node. For example, a given leaf node may store the file name, one or more dates, a file extension, a directory and/or an extension attribute for a file.

The first B-tree 302 may be based on a hash-based sort order, where hashing is performed with respect to filenames of the files. As such, searching, inserting and/or deleting metadata of the first B-tree 302 can be performed based on a hash of a given filename. Individual nodes (e.g., leaf nodes 310-320) may be searched, for example, using a comparator function associated with the hash-based sorting. In one or more implementations, the hash-based sorting may provide for compatibility with future character sets, such that filenames with future characters (e.g., unknown characters that are outside of a current character set) can be properly inserted and/or sorted within the first B-tree 302.

As shown in the example of FIG. 3, the first B-tree 302 includes leaf nodes with empty entries, corresponding to metadata that is suboptimal (e.g., fragmented and/or sparsely packed). For example, each of the leaf nodes 310 and 312 includes three entries which include metadata (e.g., depicted by hashed lines) and one entry which is empty (e.g., depicted as blank). Moreover, two of the four entries in each of the leaf nodes 314, 318 and 320 are empty. On the other hand, all four entries of the leaf node 316 are non-empty and include metadata.

While FIG. 3 illustrates the leaf nodes 310-320 as including four entries per node, it is noted that a leaf node may include fewer or more entries per node. Moreover, while FIG. 3 depicts the entries as being the same size, it possible for entries to be different sizes, or a combination of different and similar sizes.

There may be different circumstances in which the metadata within the first B-tree 302 is suboptimal (e.g., fragmented and/or sparsely packed). In one example, fragmenting may be caused by insertions to the first B-tree 302 made in association with downloading and installing operating system updates. As noted above, the electronic device 102 may download and install operating system updates (e.g., from the server 108 via the network 106) as they become available. The operating system update may cause changes to the files managed by the filesystem. For example, the operating system update may include updates to applications (e.g., default applications), including new files, modified files and/or deleted files. The changes to application files would include updates to the corresponding metadata of the filesystem.

As noted above, the first B-tree 302 stores the metadata of the filesystem. The first B-tree 302 may have been modified to account for metadata changes resulting from an operating system update. These metadata changes may be associated with insertion (e.g., or deletion) of files, thereby resulting in the first B-tree 302 becoming suboptimal (e.g., more fragmented and/or sparsely packed).

For example, metadata associated with new files may require the first B-tree 302 to add new leaf nodes. In a case where the first B-tree 302 uses hash-based sorting, the first B-tree 302 may implement proactive splitting of leaf nodes. In proactive splitting, the first B-tree 302 may not fully populate new nodes with metadata, so as to provide a buffer for potential subsequent metadata entries. Thus, the proactive splitting may result in creating empty entries within leaf nodes (e.g., leaf nodes 310, 312, 314, 318 and 320) and/or empty nodes, to provide space for potential subsequent metadata entries. However, it is possible that no subsequent metadata entries may be inserted at a respective leaf node. As such, empty entries within leaf nodes may contribute to the fragmenting and/or sparse packing of the first B-tree 302.

Another scenario which may contribute to the fragmenting and/or sparse packing of the first B-tree 302 relates to a replacement of the underlying filesystem. For example, as part of an operating system update, the filesystem (e.g., which implements the data structures for storing metadata) may be replaced. The replacement file system may implement a different sort order than the prior file system.

For example, as noted above, the first B-tree 302 may use hash-based sorting with filenames. However, prior to being stored in the first B-tree 302, the metadata may have been stored in a prior B-tree (not shown), which implemented a different sort order. For example, the prior B-tree may have employed lexicographic sorting (e.g., with filename) in accordance with a prior filesystem. Thus, the first B-tree 302 may have been created as part of the process of replacing the prior filesystem with the current filesystem. In creating the first B-tree 302, metadata entries may have been extracted from the prior B-tree (e.g., based on lexicographic sorting) and inserted into the first B-tree 302 (e.g., based on hash-based sorting).

As part of inserting the metadata entries extracted from the prior B-tree, the first B-tree 302 may proactively split leaf nodes. As noted above, the proactive splitting may result in creating empty entries within leaf nodes (e.g., leaf nodes 310, 312, 314, 318 and 320) and/or empty nodes, thereby contributing to the fragmenting and/or sparse packing of the first B-tree 302.

Thus, as part of an operating system update, the metadata entries within the first B-tree 302 may be suboptimal (e.g., fragmented and/or sparsely packed), based on modifications made to the first B-tree 302 (e.g., to account for metadata associated with new files and/or file changes) or based on the first B-tree 302 replacing a prior B-tree (e.g., corresponding to a filesystem replacement). The subject system provides for defragmenting the metadata stored in the first B-tree 302, by creating a second B-tree 322 to replace the first B-tree 302. Moreover, defragmentation of the metadata on the electronic device 102 may be triggered by the operating system update (e.g., such that the defragmentation is performed after the operating system is updated).

For example, the operating system update may include one or more instructions that cause the electronic device 102 to initiate a defragmentation process with respect to the metadata within the first B-tree 302. The one or more instructions received as part of the operating system update may correspond to a trigger to initiate the defragmentation, which includes creating the second B-tree 322 to replace the first B-tree 302.

The second B-tree 322 may be created, for example, by iterating through the first B-tree 302 to obtain metadata entries, and populating the second B-tree 322 with the obtained metadata entries. As noted above, the first B-tree 302 may be sorted based on hashing (e.g., by filename). The second B-tree 322 may also be sorted based on hashing (e.g., by filename). Thus, iterating through the first B-tree 302 may obtain the corresponding metadata entries in a sorted order for the second B-tree 322, while omitting empty entries (e.g., within the leaf nodes 310, 312, 314, 318 and 320) and/or empty nodes.

In the example of FIG. 3, the second B-tree 322 includes the nodes 326-336. The second B-tree 322 may include a primary node 324, index nodes 326-328 and leaf nodes 330-336. The file metadata (e.g., as extracted from the first B-tree 302) is stored in the leaf nodes 330-336, while the primary node 324 and the index nodes 326-328 may provide for searching and/or updating the metadata included in the leaf nodes 330-336.

As seen in FIG. 3, the second B-tree 322 may have fewer leaf nodes when compared to the first B-tree 302. For example, the second B-tree 322 has four leaf nodes 330-336, while the first B-tree 302 has six leaf nodes 310-320. In this regard, the second B-tree 322 includes the same metadata as the first B-tree 302, but the metadata entries are stored within four (e.g., densely-packed) leaf nodes 330-336, rather than spanning six leaf nodes 310-320 as in the first B-tree 302 (e.g., corresponding to sparse packing).

As such, the second B-tree 322 may correspond to a more optimal (e.g., defragmented) version of the metadata stored in the first B-tree 302. Thus, the newly-generated B-tree (e.g., the second B-tree 322) may have a reduced number of blank entries and/or blank nodes relative to the B-tree (e.g., the first B-tree 302) from which it was generated. In the example of FIG. 3, the more optimal (e.g., defragmented) version of the metadata results in the second B-tree 322 having no leaf nodes that correspond to blank entries and/or blank nodes.

In one or more implementations, it is possible for the defragmentation process to reduce the height of a suboptimal (e.g., fragmented and/or sparsely packed) B-tree. For example, when defragmenting a sub-optimal B-tree, the resulting (more optimal) B-tree may include the same metadata as the sub-optimal B-tree, but have reduced tree height (e.g., where leaf nodes are collapsed/removed, and their metadata is combined/pulled up into a tree level closer to the root node).

As noted above, the defragmentation process may be initiated as part of an operating system update. In one or more implementations, the defragmentation process may further include a crash protection mechanism, which prevents replacing the first B-tree 302 with the second B-tree 322 until the electronic device 102 determines that the metadata (e.g., in its entirety) was successfully inserted into the second B-tree 322. For example, the extraction of metadata from the first B-tree 302 and the insertion of that metadata into the second B-tree 322 may be treated as a single transaction, the completion of which is required in order to commit the second B-tree 322 as the replacement of the first B-tree 302 for the filesystem metadata.

The single transaction may be recorded within a transaction log (e.g., in the memory 204), which is updated as data records (e.g., metadata entries) are extracted from the first B-tree 302 and inserted into the second B-tree 322. Based on the transaction log, the electronic device 102 may determine whether the single transaction is complete (e.g., all metadata has been successfully moved over).

In a case where the transaction is successfully completed, the electronic device 102 may be configured to replace the first B-tree 302 with the second B-tree 322, for example, by referencing the second B-tree 322 for the filesystem metadata and/or deleting the first B-tree 302. If the transaction is interrupted and does not complete (e.g., based on a system crash of the electronic device 102), the electronic device 102 may forgo providing the second B-tree 322 as the replacement of the metadata for the filesystem, and continue using the first B-tree 302 for filesystem metadata (e.g., by continuing to reference the first B-tree 302).

In one or more implementations, use of the second B-tree 322 when compared to the first B-tree 302 may provide for reduced storage space and/or faster access time (e.g., reduced read counts) associated with the filesystem metadata. As the metadata in the second B-tree 322 is more densely-packed, it is possible to obtain the metadata entries with less reads (e.g., since the data records corresponding to the metadata entries may be grouped in a contiguous manner). For example, use of the second B-tree 322 may result in increased the B-tree utilization (e.g., a 10-15% increase) and/or may reduce metadata-related disk usage (e.g., 20-25% reduced usage), thereby providing savings with respect to the memory footprint required for metadata.

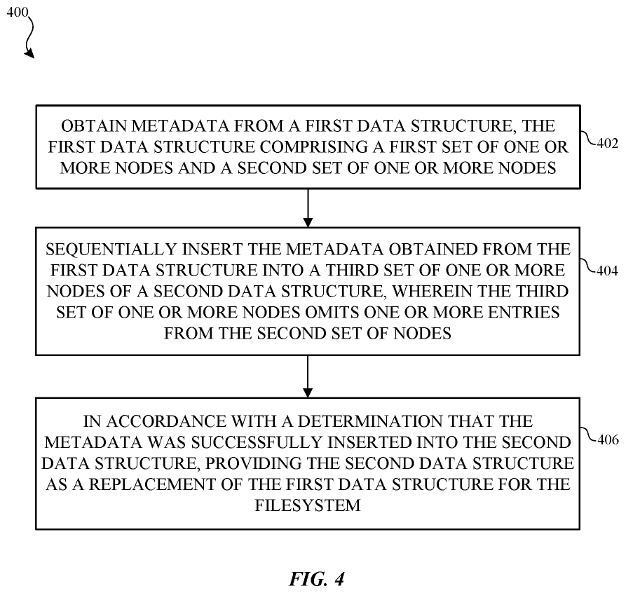

FIG. 4 illustrates an example process for defragmenting metadata of a filesystem in accordance with one or more implementations. For explanatory purposes, the process 400 is primarily described herein with reference to the electronic device 102 and the server 108 of FIG. 1. However, the process 400 is not limited to the electronic device 102 and the server 108 of FIG. 1, and one or more blocks (or operations) of the process 400 may be performed by one or more other components of the server 108 and other suitable devices (e.g., any of the electronic devices 102-105). Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

The electronic device 102 may receive a trigger from a remote server (e.g., where the trigger is included as part of an operating system update received from the server 108). In response, the electronic device 102 obtains metadata from a first data structure (402). The first data structure includes a first set of one or more nodes and a second set of one or more nodes.

The metadata from the first data structure may include at least one of a file name, a date, a file extension, a directory or extension attribute corresponding to a device application. Prior to receiving the trigger, the electronic device 102 may use the first data structure to identify the metadata for the filesystem.

The electronic device 102 inserts (e.g., sequentially inserts) the metadata obtained from the first data structure into a third set of one or more nodes of a second data structure (404). The first data structure is organized differently from the second data structure. For example, the third set of one or more nodes may omit one or more entries (e.g., empty entries) from the second set of nodes. Alternatively or in addition, the first data structure may be organized differently from the second data structure by including one or more of: a different number of entries in a node, a different number of leaf nodes and/or a different number of index nodes.

The first data structure may have been generated by inserting the metadata obtained from a third data structure (e.g., from a prior filesystem). The metadata may be organized in the first and second data structures according to a first sort order (e.g., hash-based sorting), and the metadata may be organized in the third data structure according to a second sort order (e.g., lexicographic sorting), where the first sort order is different from the second sort order.

In accordance with a determination that the metadata was successfully inserted into the second data structure, the electronic device 102 provides the second data structure as a replacement of the first data structure for the filesystem (406). Use of the second data structure when compared to the first data structure provides for at least one of reduced storage space or faster access time (e.g., reduced read counts) associated with the metadata.

In accordance with a determination that all of the metadata failed to be successfully inserted into the second data structure, the electronic device 102 may forgo providing the second data structure as the replacement of the metadata for the filesystem, and continue to use the first data structure for the metadata of the filesystem.

FIG. 5 illustrates an electronic system 500 with which one or more implementations of the subject technology may be implemented. The electronic system 500 can be, and/or can be a part of, one or more of the electronic devices 102-105, and/or one or the server 108 shown in FIG. 1. The electronic system 500 may include various types of computer readable media and interfaces for various other types of computer readable media. The electronic system 500 includes a bus 508, one or more processing unit(s) 512, a system memory 504 (and/or buffer), a ROM 510, a permanent storage device 502, an input device interface 514, an output device interface 506, and one or more network interfaces 516, or subsets and variations thereof.

The bus 508 collectively represents all system, peripheral, and chipset buses that communicatively connect the numerous internal devices of the electronic system 500. In one or more implementations, the bus 508 communicatively connects the one or more processing unit(s) 512 with the ROM 510, the system memory 504, and the permanent storage device 502. From these various memory units, the one or more processing unit(s) 512 retrieves instructions to execute and data to process in order to execute the processes of the subject disclosure. The one or more processing unit(s) 512 can be a single processor or a multi-core processor in different implementations.

The ROM 510 stores static data and instructions that are needed by the one or more processing unit(s) 512 and other modules of the electronic system 500. The permanent storage device 502, on the other hand, may be a read-and-write memory device. The permanent storage device 502 may be a non-volatile memory unit that stores instructions and data even when the electronic system 500 is off. In one or more implementations, a mass-storage device (such as a magnetic or optical disk and its corresponding disk drive) may be used as the permanent storage device 502.

In one or more implementations, a removable storage device (such as a floppy disk, flash drive, and its corresponding disk drive) may be used as the permanent storage device 502. Like the permanent storage device 502, the system memory 504 may be a read-and-write memory device. However, unlike the permanent storage device 502, the system memory 504 may be a volatile read-and-write memory, such as random access memory. The system memory 504 may store any of the instructions and data that one or more processing unit(s) 512 may need at runtime. In one or more implementations, the processes of the subject disclosure are stored in the system memory 504, the permanent storage device 502, and/or the ROM 510. From these various memory units, the one or more processing unit(s) 512 retrieves instructions to execute and data to process in order to execute the processes of one or more implementations.

The bus 508 also connects to the input and output device interfaces 514 and 506. The input device interface 514 enables a user to communicate information and select commands to the electronic system 500. Input devices that may be used with the input device interface 514 may include, for example, alphanumeric keyboards and pointing devices (also called “cursor control devices”). The output device interface 506 may enable, for example, the display of images generated by electronic system 500. Output devices that may be used with the output device interface 506 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, the bus 508 also couples the electronic system 500 to one or more networks and/or to one or more network nodes, such as the server 108 shown in FIG. 1, through the one or more network interface(s) 516. In this manner, the electronic system 500 can be a part of a network of computers (such as a LAN, a wide area network (“WAN”), or an Intranet, or a network of networks, such as the Internet. Any or all components of the electronic system 500 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method for defragmenting metadata of a filesystem of a device, the method comprising:
in response to receiving a trigger:
obtaining the metadata from a first data structure, the first data structure comprising a first set of one or more nodes and a second set of one or more nodes;
inserting the metadata obtained from the first data structure into a third set of one or more nodes of a second data structure, wherein the first data structure is organized differently from the second data structure; and
in accordance with a determination that the metadata was successfully inserted into the second data structure, providing the second data structure as a replacement of the first data structure for the filesystem,
wherein use of the second data structure when compared to the first data structure provides for at least one of reduced storage space or reduced read counts associated with the metadata.

2. The method of claim 1, wherein the first data structure is generated by inserting the metadata obtained from a third data structure, and
wherein the metadata is organized in the first and second data structures according to a first sort order, and the metadata is organized in the third data structure according to a second sort order.

3. The method of claim 2, wherein the first sort order is different from the second sort order.

4. The method of claim 1, further comprising:
in accordance with a determination that the metadata failed to be successfully inserted into the second data structure:
forgo providing the second data structure as the replacement of the metadata for the filesystem; and
continuing to use the first data structure for the metadata of the filesystem.

5. The method of claim 1, wherein the trigger is received from a server remote from the device, and
wherein the trigger is included as part of an operating system software update.

6. The method of claim 1, further comprising:
prior to receiving the trigger, using the first data structure to identify the metadata for the filesystem.

7. The method of claim 1, wherein the metadata from the first data structure comprises at least one of a file name, a date, a file extension, a directory or extension attribute corresponding to a device application.

8. The method of claim 1, wherein the third set of one or more nodes omits one or more entries from the second set of nodes.

9. A device, comprising:
at least one processor; and
a memory including instructions for defragmenting metadata of a filesystem that, when executed by the at least one processor, cause the at least one processor to:
in response to receiving a trigger from a server remote from the device:
obtain the metadata from a first data structure, the first data structure comprising a first set of one or more nodes and a second set of one or more nodes;
insert the metadata obtained from the first data structure into a third set of one or more nodes of a second data structure, wherein the third set of one or more nodes omits one or more entries from the second set of nodes; and
in accordance with a determination that the metadata was successfully inserted into the second data structure, provide the second data structure as a replacement of the first data structure for the filesystem.

10. The device of claim 9, wherein the first data structure is generated by inserting the metadata obtained from a third data structure, and
wherein the metadata is organized in the first and second data structures according to a first sort order, and the metadata is organized in the third data structure according to a second sort order.

11. The device of claim 10, wherein the first sort order is different from the second sort order.

12. The device of claim 9, wherein the instructions further cause the at least one processor to:
in accordance with a determination that the metadata failed to be successfully inserted into the second data structure:
forgo providing the second data structure as the replacement of the metadata for the filesystem; and
continuing to use the first data structure for the metadata of the filesystem.

13. The device of claim 9, wherein the trigger is included as part of an operating system software update.

14. The device of claim 9, wherein the instructions further cause the at least one processor to:
prior to receiving the trigger, using the first data structure to identify the metadata for the filesystem.

15. The device of claim 9, wherein the metadata from the first data structure comprises at least one of a file name, a date, a file extension, a directory or extension attribute corresponding to a device application.

16. The device of claim 9, wherein use of the second data structure when compared to the first data structure provides for at least one of reduced storage space or reduced read counts associated with the metadata.

17. A computer program product comprising code, stored in a tangible computer-readable storage medium, for defragmenting metadata of a filesystem of a device, the code comprising:
in response to receiving a trigger from a server remote from the device:
code to obtain the metadata from a first data structure, the first data structure comprising a first set of one or more nodes;
code to insert the metadata obtained from the first data structure into a second set of one or more nodes of a second data structure, wherein the second set of one or more nodes omits one or more entries from the first set of nodes; and
code to, in accordance with a determination that the metadata was successfully inserted into the second data structure, provide the second data structure as a replacement of the first data structure for the filesystem.

18. The computer program product of claim 17, wherein the first data structure is generated by inserting the metadata obtained from a third data structure, and
wherein the metadata is organized in the first and second data structures according to a first sort order, and the metadata is organized in the third data structure according to a second sort order.

19. The computer program product of claim 18, wherein the first sort order is different from the second sort order.

20. The computer program product of claim 17, wherein the trigger is included as part of an operating system software update.
